(19) United States
(12) Patent Application Publication
(10) Pub. No.: US 2012/0135184 A1
(43) Pub. Date: May 31, 2012

(54) REINFORCED WARP LOOP BONDED SEAM FOR AN INDUSTRIAL TEXTILE

(75) Inventor: Ian Gerald Lang, Almonte (CA)

(73) Assignee: ASTENJOHNSON, INC., Charleston, SC (US)

(21) Appl. No.: 13/388,310

(22) PCT Filed: Aug. 27, 2010
(86) PCT No.: PCT/CA2010/001330

§ 371 Date: Feb. 1, 2012

(30) Foreign Application Priority Data
Aug. 28, 2009 (GB) 0915044.2

(51) Int. Cl. B32B 3/06; D03D 1/00; B32B 37/04; D03D 41/00

(52) U.S. Cl. 428/99; 139/11; 139/383 AA; 156/73.2

(57) ABSTRACT

A seaming area for a woven industrial fabric, a fabric, and a method of providing a seaming area and seam. The fabric comprises at least a first set of warp yarns interwoven with weft yarns, either in a single layer, or multiple layers in which the warp yarns can optionally be stacked. At each seaming area, yarns of a first group pass around and in contact with the fabric edge, and yarns of a second group pass around the fabric edge to form protruding loops. Free ends of the warp yarns are bonded to the fabric body, over warp yarns or weft yarns, or combinations thereof. Opposing fabric ends are brought together, and the loops interdigitated to be joined by a pintle or coil to render the fabric endless. The seaming area and the method provide increased seam strength and reliability, with significant reduction of time and costs of manufacture.

### FIELD OF THE INVENTION

This invention relates to industrial woven textile fabrics, and the provision of seaming areas at opposed ends of such fabrics to be joined in a seam. More particularly, the invention relates to improvements in the provision of seaming loops to warp yarns, where the yarn ends are secured to the fabric body in a bonding process.

### BACKGROUND OF THE INVENTION

Industrial textiles such as those intended for use in the dryer section of a papermaking machine are generally flat woven using a wide industrial loom. In these fabrics, the warp yarns will be oriented in the machine direction (MD) or running direction, while the weft yarns will be interwoven across the warp and thus oriented in the cross-machine direction (CD) or transversely to the warp in the plane of the fabric. Examples of fabrics of this type are described in U.S. Pat. No. 4,209,290 (Buchanan et al.) and U.S. Pat. No. 5,103,874 (Lee) and its continuations and divisions. In these fabrics, the warp yarns will have a generally rectangular or square cross-sectional configuration so as to maximize contact between the fabric and product conveyed thereon. Flat woven fabrics such as these must be seamed prior to use so that the opposed ends can be joined together to render the fabric endless on the machine for which they are intended. Pin seams or streamline coil seams such as are well known in the art are generally used for this purpose, both of which require a pintle or pin to close them.

Prior to the present invention, seams intended for use in woven industrial textiles having two layers or sets of warp yarns, such as those described in U.S. Pat. No. 4,209,290 (Buchanan et al.) and U.S. Pat. No. 5,103,874 (Lee), were generally formed by the MD yarns from one fabric surface being turned around either the last weft yarn in the fabric, or a spacer positioned after the last weft yarn, thus forming respectively retainer loops and seaming loops, the free ends being rewoven back into the fabric, as discussed below.

This method of the prior art is shown in FIGS. 6 and 7, in which the warp yarns 22 are turned at or proximate to the outermost of the weft yarns 21, and are then returned in a manual or automated reweaving process into the path of the warp yarn 23 located on the second planar surface of the fabric and beneath yarn 22. The warp yarn 23 is trimmed at some distance back from the seaming face of the fabric and the warp 22 is woven according to the path of the warp 23 until it reaches the trimmed yarn end. The free yarn ends or “tails” of warp yarns 22 and 23 are further trimmed (if necessary) so as to locate them towards the fabric interior and thus removed from both the wear plane and the sheet contact plane. The strength of the seam formed in this manner is dependent upon the distance one warp yarn (e.g. 22) is interwoven with the weft yarns at the fabric end until it reaches the second trimmed warp end 23; i.e. it is the crimp of the warp yarn as it is interlaced with the weft that holds it in place and provides the necessary seam strength.

To accommodate the loops from the opposite fabric end and allow for their interdigitation to form the closed seam (so that the seaming loops from the two fabric ends can be intermeshed together and a pin inserted into a common channel), it is necessary to have open spaces on opposite sides of the fabric along the seam face (i.e. locations at which there are no warp seam loops). This type of arrangement can be seen in FIG. 7, where each yarn 22 forms a seam loop and each yarn 24 forms a retainer loop (to hold the last weft yarn 21 in place) and provides the necessary opening to accommodate a loop from the opposite side. The opposed fabric ends are brought together, the loops being interdigitated and joined by a suitable means, such as the insertion of a pintle 30.

The use of seaming loops of this nature is also well known for single layer fabrics, for example U.S. Pat. No. 5,454,161 (Scarfe), U.S. Pat. No. 5,488,976 (Lorenz) and U.S. Pat. No. 5,713,398 (Josef).

Seam creation in a woven textile is a process which, although partially automated, requires a high degree of training, skill, dexterity and time on the part of an experienced seamer. The cost of forming such seams, particularly the reweaving steps, accounts for a high proportion of the cost of making the fabric. Thus, it would be desirable if a means were available whereby a reliable and high strength seam could be formed in fabrics such as are described above without the need to reweave the warp ends back into the fabric to the extent presently required. Such a means would reduce labour costs associated with seam formation resulting in lower overall manufacturing costs, and should provide a seam of higher strength and reliability than has previously been available.

It has now been found that a seaming area can be provided which is similar in appearance to known seaming areas such as shown in FIGS. 6 and 7, or known seaming areas for single layer fabrics but in which the high costs of reweaving the warp yarns in the manner described above are avoided by the use of a bonding process, in which each of the warp yarns is turned about a fabric end and then bonded to one fabric surface, preferably to a flat planar area, by a bonding process such as laser welding, ultrasonic welding, application of an adhesive or a similar chemical or energy bonding means. For fabrics woven using two sets of warp yarns in two layers, each of the warp yarns from one fabric surface is turned about the fabric end and bonded to the second fabric surface.

### DISCUSSION OF THE PRIOR ART

Techniques and means of welding or bonding yarns to form a high strength seam are known. For example, U.S. Pat. No. 5,377,722 to Jaala discloses a fabric seam suitable for a dryer fabric made by removing some material from the warp on the MS side of the fabric, folding the fabric ends so that they are double, and then stitching the doubled part together and attaching a spiral for seaming. The stitches are so placed that their yarns lie between the warps and are placed below the contact area of the warps so that they will not be exposed to wear. The stitch portion remote from the seam is locked in position by an adhesive, such as silicone, which is applied within the fold area on the wear surface of the fabric.

U.S. Pat. No. 5,464,488 to Servin discloses a method for bonding two woven fabric layers by ultrasonic welding. The layers are overlapped and their yarns softened by the ultrasonic apparatus; the yarns of each layer are then pressed together, causing them to adhere to one another. The method may also be used to attach seaming coils at a foldback, the foldback being welded into position to secure a flap, or repair a hole.

U.S. Pat. No. 5,713,399 to Collette et al. discloses a method of making a papermaker's fabric, and the fabric so obtained, by manufacturing a narrow woven fabric strip, spirally winding the strip so that a first lateral edge abuts a second lateral edge of an adjacent turn, and then ultrasonically seaming the abutting edges together. The fabric strip, which is provided with a fringe approximately 4 mm wide, in which there are no warp yarns, is unwound so that the lateral fringes overlap or underlap an immediately adjacent similarly prepared strip, and the non-fringed bodies of the two fabrics abut one another in a common plane. The fringed portions thus form a lap joint while the fully woven body portions form a butt joint. The overlapped portions of the adjacent strips are compressed between an ultrasonic welding apparatus and anvil and thereby welded. The anvil is a rotating wheel over which the seam is welded in a continuous process.

U.S. Pat. No. 6,440,881 to Ercken discloses a seamed press felt wherein the opposed fabric ends which are to be joined are held together by means of an adhesive; there is no mechanical join such as a pin seam. According to the invention, the fabric ends are cut to form overlapping stepped surfaces about 5-15 cm long. One or both surfaces are provided with an adhesive layer, such as a hot melt adhesive or adhesive fibers. The step surfaces are then overlapped and the joint formed by activating the adhesive; the fabric can either be flat or endlessly woven.

U.S. Pat. No. 7,005,038 to Maguire discloses a seam for a metal wire belt for corrugating or liner board applications which is intended to overcome problems of seam fatigue and failure due to loss of strength and malleability at the brazed area of a welded seam for metal wires.

JP 2000/239940 (Nippon Filcon Co. Ltd.) discloses a seam for an industrial textile in which the seaming loops are formed by welding the tips of adjacent warp yarns in a portion of the fabric made up only of warps which is created by removing weft yarns on both fabric ends.

US 2006/0180273 to Beck discloses a method for splicing or joining a multilayer fabric such as a forming fabric by first separating the layers from each other in the region of the free ends (where the splice is to be located). The ends are joined by first overlapping and then linear fusing the yarns under pressure and at an elevated temperature. A reinforcing strip or a perforated adhesive layer is then located in between the layers; the adhesive is then activated or an adhesive is applied to the reinforcing strip to join it to the bottom layer.

US 2007/0028997 to Best et al. discloses a forming fabric in which, in order to enhance stability, warp and weft yarns are fused to one another at their crossing points by means of laser energy; the fabric includes a first set of yarns which absorb laser energy readily.

US 2008/0230139 to Enqvist et al. discloses a seam for a dryer fabric having at least two superposed MD yarn systems, similar to that described in U.S. Pat. No. 5,148,838. According to the disclosure, alternating PS MD yarns form seaming loops while the remainder form the seam edge; all are fastened off on the MS. According to the disclosure, these “fasten-off” rows do not need to be reinforced with an adhesive because they are separated from each other in the fabric. However, this disclosure does not address the fundamental problem of eliminating at least some of the labour required to weave back the warp yarns into the fabric body from the seam area.

WO 2009/032271 to Eagles discloses the use of laser energy to weld or melt selected locations of a papermaking fabric, but in particular at the seam region so as to increase seam strength and durability, while maintaining fabric properties at the seam region essentially the same as within the fabric body. The publication is directed to a method of treating a yarn by providing a material that absorbs short wavelength infrared energy to a fiber which is normally transparent to this energy, and then selectively melting, fusing or bonding the yarn to itself or another yarn by exposure to the energy.

WO 09032666 to Lafond et al. discloses ultrasonic gap welding of flat woven fabrics and specifically, a method of ultrasonic welding the seam termination yarn ends of a fabric using a controlled gap.

Loop-forming seams intended to accept a pintle or seaming coil are well known from the prior art. For example, GB 1529728 to MacBean discloses a woven fabric including a plurality of pre-crimped replacement MD oriented monofilaments in the seam area intended to improve the flatness and stability of the seam area. JP 2005-096109 to Kitamura et al. discloses a loop forming seam for a sludge dewatering fabric in which alternating long and short loops are formed to accept two pintles and thereby increase seam strength and the service life of the fabric. U.S. Pat. No. 5,238,027 to Lee discloses a stacked warp type dryer fabric including orthogonal seaming loops formed from pre-crimped replacement yarns; a single rectangular stuffer yarn is inserted on each side of the pintle. U.S. Pat. No. 5,188,884 to Smith discloses a low marking dryer fabric pin seam including smaller diameter weft (in comparison to those in the fabric body) near the pintle for a fraction or a full repeat of the weave; this allows small pintle loops to be formed using a length of warp yarn no greater than one warp crimp length. U.S. Pat. No. 5,601,120 to Kuckart et al. discloses a pin seam including double concentric seam loops for a stacked warp type dryer fabric; after heatsetting, a portion of the CD yarns adjacent the seam area are removed and alternate stacked MD yarn pairs are woven back to form a pair of nested orthogonal loops.

None of the prior art specifically addresses a means of forming a reinforced seam for a fabric by turning the MD yarns back upon the fabric body and then bonding the yarns to form high strength loops.

### SUMMARY OF THE INVENTION

The present invention therefore seeks to provide a seaming area for opposing ends of a flat woven industrial fabric comprised of interwoven polymeric warp and weft yarns, such that two seaming areas can be joined together to create a reinforced seam. The seaming area is suitable for any industrial woven fabric, particularly one having at least two sets of warp yarns, and is particularly suitable for fabric designs which utilize generally rectangular monofilament warp yarns, and in which the warp yarns are oriented in the MD and predominate on one or both of the two planar fabric surfaces, such as are described in U.S. Pat. No. 4,290,209. The seaming area and method of the invention are especially suitable for fabrics having these characteristics and in which the warp yarns are organized in a stacked relationship, such as the fabrics disclosed in U.S. Pat. No. 5,092,373.

In general, in the seams according to this invention, the MD warp yarns are turned back from one surface of the fabric onto the other to form both seaming and retainer loops. A seaming loop is a yarn loop formed at one of the opposed fabric ends and which is intended to accept a seaming element, such as a seaming coil or a pintle or pin, so as to form a join with a similar loop formed at opposite fabric end. A retainer loop is a yarn loop formed at one of the opposed fabric ends which wraps around the last CD or weft yarn in the fabric to hold that weft yarn in place. The free ends of the yarns forming the seaming and retainer loops are then bonded to the surfaces of the warp yarns located either immediately above, below or adjacent to and in proximity of the last weft yarns adjacent a fabric edge, or to selected weft yarns, by means of any suitable bonding process, such as laser energy, ultrasonic energy, or adhesives. The bonded warp yarn ends are then trimmed back by an appropriate amount so that the yarns terminate at about the last bond point. In one embodiment, the weft yarns beneath the bonded warp ends may be of a smaller effective cross-sectional size (e.g. are of a smaller diameter) than those in the fabric body so that fabric caliper at the seam region where the warp yarns have been turned back and bonded remains relatively unchanged in comparison to that of the fabric body.

The invention therefore seeks to provide a seaming area for seamable end regions of a woven industrial fabric, the fabric comprising at least a first set of warp yarns interwoven with weft yarns and having free ends, the first set of warp yarns comprising at least a first group and a second group, the fabric comprising a fabric body and a first and second seamable end region each comprising a fabric edge, wherein at the seaming area

(i) the yarns of the first group pass around and in contact with the fabric edge, and the yarns of the second group pass around the fabric edge to form a plurality of loops protruding from the fabric edge; and
(ii) the free ends of each of the warp yarns of the first set are bonded to yarn material of the fabric body, the yarn material being selected from surfaces of the warp yarns of the first set, surfaces of the weft yarns, and combinations thereof.

The invention further seeks to provide a woven industrial fabric comprising at least a first set of warp yarns interwoven with weft yarns and having free ends, the first set of warp yarns comprising at least a first group and a second group, the fabric comprising a fabric body and a first and second seamable end region each comprising a fabric edge, wherein at the seaming area

(i) the yarns of the first group pass around and in contact with the fabric edge, and the yarns of the second group pass around the fabric edge to form a plurality of loops protruding from the fabric edge; and
(ii) the free ends of each of the warp yarns of the first set are bonded to yarn material of the fabric body, the yarn material being selected from surfaces of the warp yarns of the first set, surfaces of the weft yarns, and combinations thereof.

In the seaming areas of the invention, and in woven industrial fabrics of the invention, the preferable and advantageous features include the following.

Preferably the fabric comprises at least first and second sets of warp yarns interwoven with the weft yarns in first and second layers, and the yarn material is selected from surfaces of the warp yarns of the first set, surfaces of the warp yarns of the second set, surfaces of the weft yarns, and combinations thereof. More preferably, in fabrics comprising two layers of warp yarns, the first and second sets of warp yarns are provided as stacked pairs such that each yarn of the first set is stacked with a yarn of the second set in a vertical plane through the fabric, and each yarn of the second set is stacked with a yarn of the first set in a vertical plane through the fabric, and the yarn material is selected from surfaces of the warp yarns of the first set, surfaces of the warp yarns of the second set, surfaces of the weft yarns, and combinations thereof.

Preferably, the yarns of the first group are alternated with the yarns of the second group, such that the loops in a first seaming area at the first seamable end region are interdigitatable with the loops in a second seaming area in the second seamable end region, and the loops when interdigitated are alignable to receive a seam closure means selected from a pintle and a coil.

Preferably, the free ends of each of the warp yarns of the first set are bonded to the yarn material by a bonding step selected from at least one of laser welding, ultrasonic welding, application of an adhesive, and application of chemically reactive materials. Optionally, in fabrics comprising two layers of warp yarns, the free ends of the warp yarns of the second set are secured to surfaces of selective ones of the weft yarns.

Preferably, selected weft yarns adjacent the seam area have an effective thickness in a vertical plane through the fabric which is less than the thickness of the remaining weft yarns in the fabric body, such lesser thickness having a value (D−N) wherein D is the thickness dimension of the remaining weft yarns in the fabric body, and N is the thickness dimension of a selected one of the warp yarns. To provide such reduced effective thickness, the selected weft yarns may be constructed as hollow yarns, or as multifilament yarns, or cabled monofilament yarns. Alternatively, the selected weft yarns are constructed of a material comprising a heat-softenable and deformable polymer.

Preferably, the warp yarns of the first set have a substantially rectangular cross-sectional shape; and in fabrics comprising two layers of warp yarns, preferably the warp yarns of both the first and the second sets have a substantially rectangular cross-sectional shape.

The invention further seeks to provide a method of providing a seaming area to a woven industrial fabric, the fabric comprising at least a first set of warp yarns interwoven with weft yarns to provide a fabric body and a first and second seamable end region each comprising a fabric edge, the method comprising the steps of

(a) dividing the warp yarns of the first set proximate each of the fabric edges into at least a first and a second group;
(b) turning the yarns of the first group at the respective fabric edge to pass around and in contact with the fabric edge;
(c) turning the yarns of the second group at the respective fabric edge to pass around the fabric edge to form a plurality of loops protruding from the fabric edge; and
(d) bonding free ends of each of the warp yarns of the first set to yarn material of the fabric body, the yarn material being selected from surfaces of the warp yarns of the first set, surfaces of the weft yarns, and combinations thereof.

The method of the invention is particularly advantageous where the fabric comprises at least first and second sets of warp yarns interwoven with the weft yarns in first and second layers, and wherein the selecting of the yarn material in step (d) comprises selection from surfaces of the warp yarns of the first set, surfaces of the warp yarns of the second set, surfaces of the weft yarns, and combinations thereof. In such fabrics, preferably the first and second sets of warp yarns are provided as stacked pairs such that each yarn of the first set is stacked with a yarn of the second set in a vertical plane through the fabric, and each yarn of the second set is stacked with a yarn of the first set in a vertical plane through the fabric, and the yarn material is selected from surfaces of the warp yarns of the first set, surfaces of the warp yarns of the second set, surfaces of the weft yarns, and combinations thereof.

Optionally, in fabrics comprising two layers of warp yarns, the method further comprises, before step (b), the step of securing free ends of the warp yarns of the second set to surfaces of selective ones of the weft yarns.

Preferably, the dividing in step (a) is performed such that the yarns of the first group are alternated with the yarns of the second group, such that the loops in a first seaming area at the first seamable end region are interdigitatable with the loops in a second seaming area in the second seamable end region, and the loops when interdigitated are alignable to receive a seam closure means selected from a pintle and a coil.

Preferably, the bonding of step (d) comprises a method selected from at least one of laser welding, ultrasonic welding, application of an adhesive, and application of chemically reactive materials.

Preferably, the method further comprises, before step (a), the step of

(a.0) providing selected weft yarns adjacent the seam area having an effective thickness in a vertical plane through the fabric which is less than the thickness of the remaining weft yarns in the fabric body, such lesser thickness having a value (D−N) wherein D is the thickness dimension of the remaining weft yarns in the fabric body, and N is the thickness dimension of a selected one of the warp yarns. To provide such reduced effective thickness, the selected weft yarns may be constructed as hollow yarns, or as multifilament yarns, or cabled monofilament yarns. Alternatively, the selected weft yarns are constructed of a material comprising a heat-softenable and deformable polymer.

Preferably, the warp yarns of the first set have a substantially rectangular cross-sectional shape. In fabrics comprising two layers of warp yarns, preferably the warp yarns of both the first and the second sets have a substantially rectangular cross-sectional shape.

The invention further seeks to provide a method of forming a seam for a woven industrial fabric, comprising the steps of

(a) weaving the fabric on a loom;
(b) providing at each seamable end of the fabric a seaming area by the method of the invention; and
(c) bringing the seamable ends of the fabric together and securing them in the seam.

Optionally, step (b) can be performed while the fabric is on the loom; alternatively, before step (b), the method comprises removing the fabric from the loom.

### BRIEF DESCRIPTION OF THE DRAWINGS

FIG. 1 is an isometric view of a seaming area of the invention;

FIG. 2A is a sectional view of the seaming area of FIG. 1 taken along the line A-A, showing a seaming loop;

FIG. 2B is a sectional view corresponding to FIG. 2A, with reduced effective size of selected weft yarns at the fabric edge by the use of smaller weft yarns at selected locations;

FIG. 3A is a sectional view of the seaming area of FIG. 1 taken along the line B-B, showing a retainer loop;

FIG. 3B is a sectional view corresponding to FIG. 3A, with reduced effective size of selected weft yarns at the fabric edge by the use of smaller weft yarns at selected locations;

FIG. 4 is a sectional view corresponding to FIG. 3A, with reduced effective size of selected weft yarns at the fabric edge by the use of hollow weft yarns at selected locations;

FIG. 5 is a sectional view corresponding to FIG. 3A, with reduced effective size of selected weft yarns at the fabric edge by the use of multifilament or cabled monofilament weft yarns at selected locations;

FIG. 6 is a sectional view of a seaming area of the prior art, showing the path of a warp yarn as it is rewoven into the fabric; and

FIG. 7 is a top view of two opposed seaming areas of FIG. 4 being brought together to form a seam.

### DETAILED DESCRIPTION OF THE DRAWINGS

As used in the following discussion, the terms “top”, “bottom”, “left”, “right”, “up” and “down” refer to orientations or directions in the illustrations only; the seams resulting from the joining of seaming areas of this invention may be formed with the warp yarns terminating on either the “top” or “bottom” of the fabric as it will be used on the machine for which it is intended.

The term “float” in relation to the warp yarns refers to a region where a warp yarn passes over two or more consecutive weft yarns in the weave pattern.

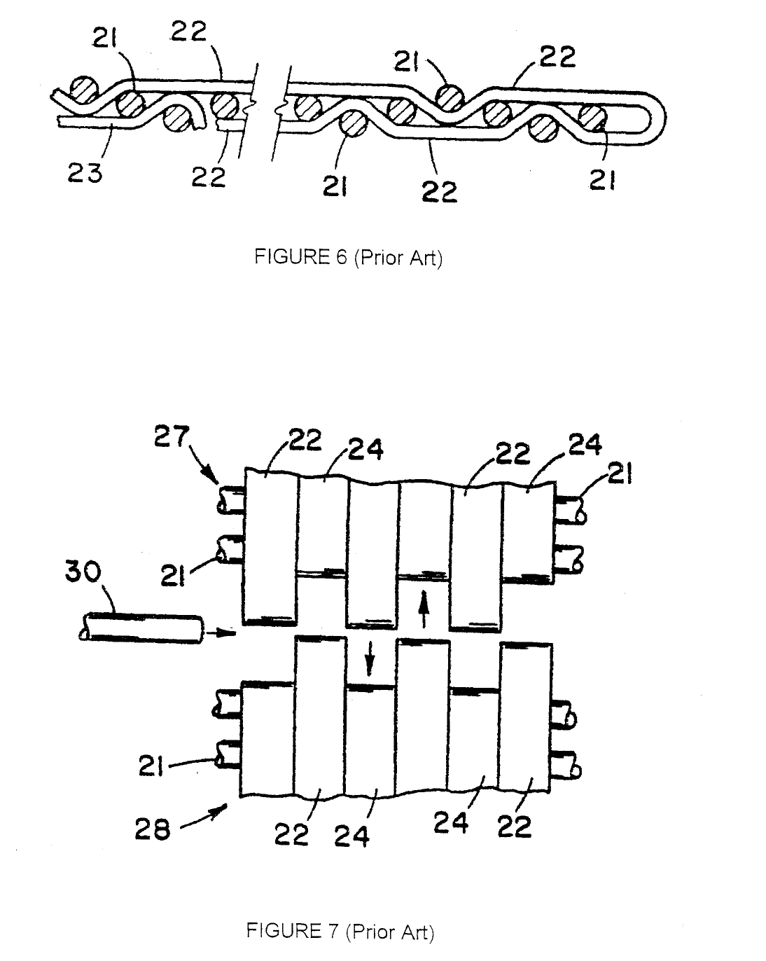

Further, references to known and conventional methods of seaming fabrics for which the present invention is suitable should be understood in relation to the general discussion above of the prior art with reference to FIGS. 6 and 7.

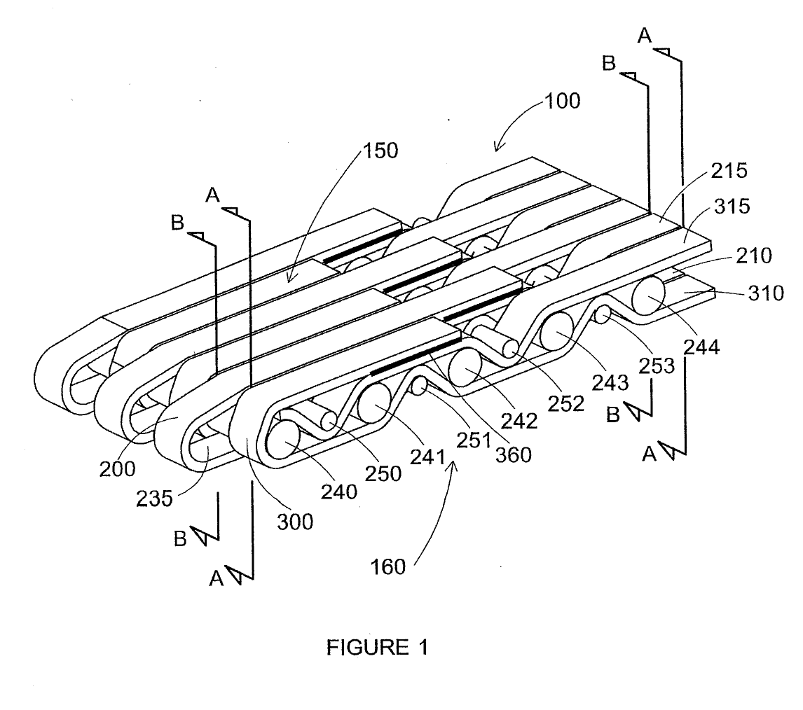

Referring first to FIG. 1, a fabric 100 has a stacked warp construction, similar to that shown in FIGS. 6 and 7, and includes a first (top) surface 150 and second (bottom) surface 160 formed by the interweaving of warp yarns 310, 315 and 210, 215 in sequence with weft yarns 240, 250, 241, 251, 242, 252, 243, 253 and 244. Each of the weft yarns 240, 241, 242, 243, 244 has a larger cross sectional area than the weft yarns 250, 251, 252, 253 and they each alternate in placement within the fabric weave construction as shown in FIG. 1. It will be understood that, except for the features described below in relation to the creation of the seaming area, in particular the formation of loops from the ends of the warp yarns, the construction and arrangement of the yarns as shown in FIG. 1 will continue throughout the length and width of the body of the fabric 100 and the features of the first end will be repeated at the opposing fabric end.

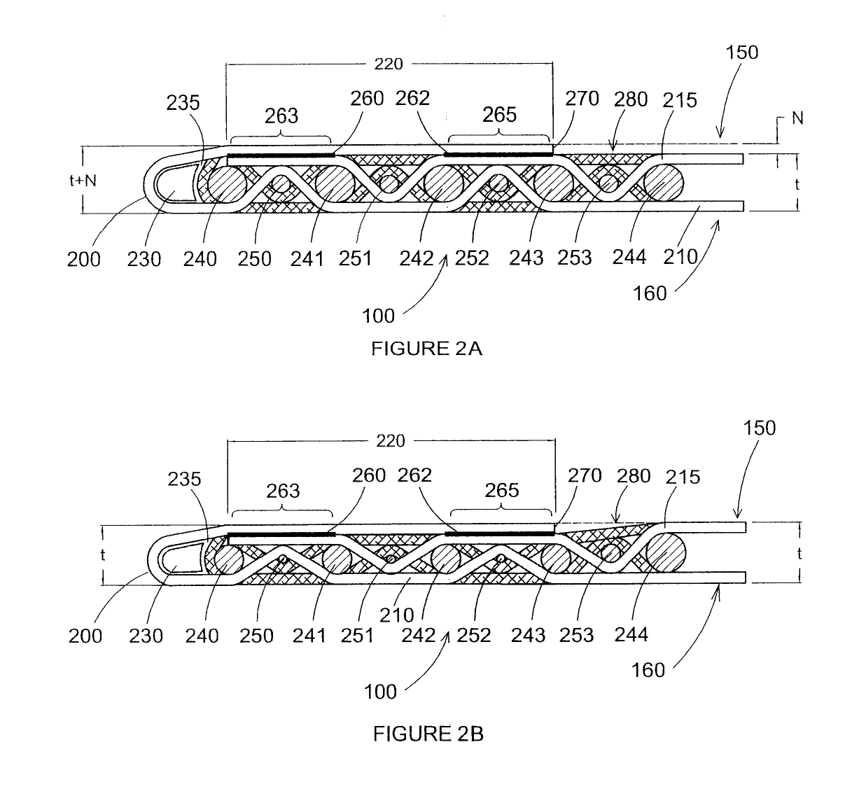

In the seaming area shown in FIG. 1, seaming loops 200 are formed by warp yarn 210 and each alternate warp yarn as they are looped back from their placement in bottom surface 160 around spacer 230 (shown in FIGS. 2A, 2B) onto the top surface 150, and retainer loops 300 are formed by warp 310 and each alternate warp yarn as they are looped back from bottom surface 160 around the last weft yarn 240 and onto top surface 150.

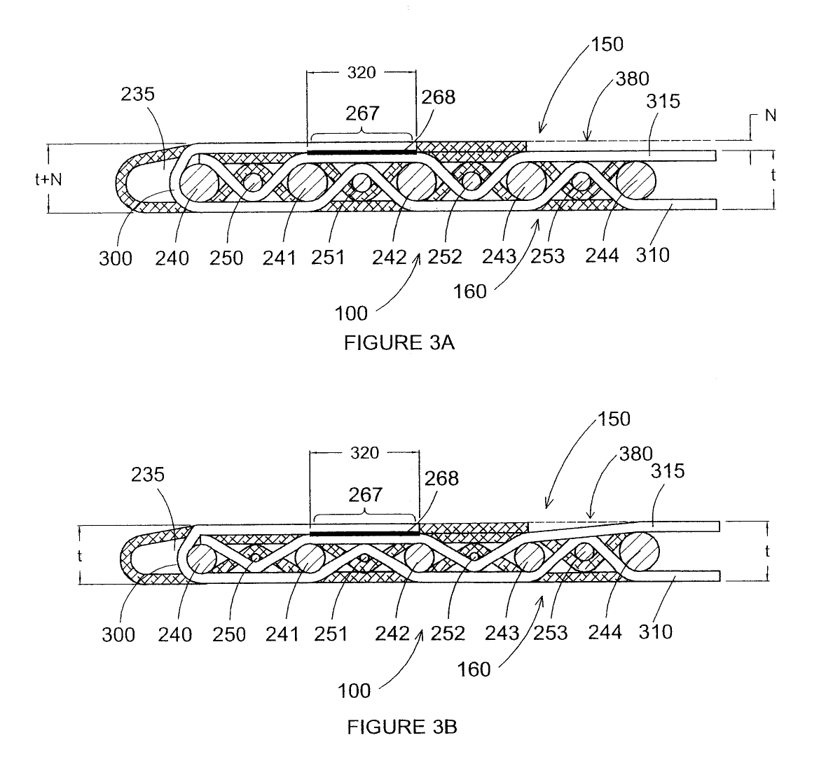

As will be apparent to those skilled in the art, when forming a seaming area in accordance with the teachings of the present invention, the retainer loops 300 would have to be created before the seaming loops 200. As can be seen from FIG. 1, the outer edge of the seaming area is comprised of both seam loops 300 and retainer loops 200. Typically, in stacked warp fabrics such as shown, 50% of the warp yarns will be used to form such seaming loops, while the remaining 50% will be retainer loops. The formation of seaming loops according to the principles of the present invention is discussed below with reference to FIGS. 2A and 2B, and the formation of retainer loops is discussed below with reference to FIGS. 3A and 3B.

Referring to FIG. 2A, which is a cross-section taken along the line A-A in FIG. 1, a seaming loop 200 is formed by passing a warp yarn 210 (which has been interwoven with the weft yarns 240, 250, 241, 251, etc. to the right of the Figure) from bottom surface 160 of the fabric 100, around a spacer 230, and then laid over an overlap portion 220 of the path of the warp yarn 215 located on the top surface 150 of the fabric 100, so that it lies upon and is in contact with it. The spacer 230 is used during the seam formation process to provide the required channel 235 in the seaming loops 200 to accommodate a pintle or seaming coil (not shown) which will later be installed so as to join the two fabric ends thereby rendering the fabric endless for use on the machine for which it is intended. Maximum contact between the warp yarns 210, 215 occurs at the locus where the top warp yarn 215 fauns a float over groups of three weft yarns 240, 250, 241 and 242, 252, 243, as shown in the area overlap portion 220 where warp yarn 210 is bonded to warp yarn 215 at bonding locations 263, 265 by bonds 260, 262 to form a securely bonded seam loop. Bonding can be accomplished by means of an appropriate adhesive or other chemical that will react with the polymer component of the yarns, or more preferably by means of ultrasonic energy or laser energy, which is less disruptive to the fabric and seam properties. In this illustration, the overall length of the overlap portion 220 including bonded areas 263, 265 is sufficient to cover at least about one repeat of the fabric weave pattern, but this length can be increased or decreased depending on the amount of tensile strength required for the seam and thus the strength of the bond.

As can be seen from FIG. 2A, once the warp yarn 210 forms seaming loop 200 and is subsequently bonded onto warp 215 at areas 263 and 265, the warp end 270 will form a discontinuity as at 280 due to the thickness N of the yarn 210. This factor and its resolution are discussed in greater detail below.

Referring now to FIG. 3A, which is a cross-section taken along the line B-B in FIG. 1, a retainer loop 300 retains, or holds, the last weft yarn, shown here as weft yarn 240, in place at the edge of the fabric to maintain fabric integrity. The retainer loops 300 are alternated with seaming loops 200, which do not secure weft yarn 240, but are enlarged to accommodate a pintle or seaming coil. Retainer loops 300 are formed by passing a warp yarn 310, which has been interwoven with the weft yarns 240, 250 to the right of the figure, from the bottom surface 160 of the fabric 100, around the last weft yarn 240 to secure it at the fabric edge, and then over a portion of the path 320 of the vertically stacked warp yarn 315 on the top of the fabric 150 so that it lies upon it. Maximum contact between the warp yarns 310 and 315 occurs at the locus 320 where the warp yarn 315 forms a float over a group of three weft yarns, which is the preferred bonding location 267 at which bond 268 is provided to warp yarns 310, 315.

In the fabric shown in FIGS. 1-3, several features are apparent:

a) The warp yarns forming both the seam loops and retainer loops are terminated at differing distances back from the last weft yarn in the fabric. This is not necessary, and for some applications it may be desirable to terminate them at the same distance back, at random locations or at least at differing distances from the last weft to minimize discontinuities and improve or maintain seam strength.
b) The warp yarns forming the seam and retainer loops are bonded over warp yarn floats in the regions 263, 265 or 267 which are formed by one or two repeats of the weave pattern on the top surface. The preferred number of floats will depend on the particular application, but in general the bonding will preferably be made over one, three or more floats depending on the prevailing conditions in the machine for which the fabric is intended.
c) The warp yarns 215, 315 on the top surface 150 of the fabric and in direct contact with the weft yarns 240, 250 may also be bonded to those weft yarns 240, 250 so as to secure the warp yarns 215, 315 in place. The lower warp yarns 210, 310 are then folded around the fabric end forming retainer and seam loops 300, 200 and each is then bonded in turn to the already secured warp yarn.
d) The preferred bonding method used to secure the warp yarns at the seam area is laser welding. If the warp yarns contain carbon black or other suitable materials that absorb laser energy, then it is not necessary to use a “primer” or any other energy absorbing material to affect a weld. However, if the yarns are effectively transparent to laser energy, then it may be necessary to use a primer such as ClearWeld® or other similar material. Alternate bonding methods that may be suitable include: ultrasonic welding of the yarn components, application of an adhesive to the appropriate yarn components or the use of chemically reactive materials which react with the yarn polymer to effectively melt and allow bonding.

As shown in FIGS. 1, 2A and 3A, the warp yarns 210, 215 and 310, 315 of the fabric run from right to left and are arranged in stacked relationship one above the other in the manner described in U.S. Pat. No. 5,148,838. The weft yarns 240, 250, 241, 251, etc. are shown in cross-section and are of two differing (and alternating) sizes with the larger weft yarns 240, 241, 242, 243, 244 having a diameter D1, typically of about 1.0 mm in diameter, and the smaller weft yarns 250, 251, 252, 253 having a diameter D2, typically of about 0.7 mm. The fabric has a thickness (or caliper) “t” which is the sum of the thickness of the warp yarns 210, 215, 310 and 315, plus the diameter D1 of the large weft yarns 240, 241, 242, 243, 244. If D1 is about 1.0 mm, and the thickness of the individual warp yarns 240, 250, 241, 251, etc is N and is about 0.26 mm, then the fabric caliper “t” will be:

t=N+N+D1=0.26+0.26+1.0=1.52 mm.

It will be appreciated that the area where the two warp yarns 210, 215 in FIG. 2A or 310, 315 in FIG. 3A are overlaid and bonded to one another as at 263, 265 and 267 respectively will be thicker (i.e. have a larger caliper) than the “body” portion of the fabric which is not involved in the seam area. The body of the fabric will have a thickness “t” equal to the diameter D1 of the larger weft yarns 240, 340 plus 2 times the thickness N of the warp yarns. In the seam region where the lower warp yarn 210, 310 is overlaid on and bonded to the upper warp yarn 215, 315 the fabric thickness t will be increased by the thickness N of one additional warp yarn, to provide a seam caliper t=(N+N+N+D1). In many instances, this will not create a problem as the product being manufactured using the fabric may be tolerant to this variation in height, or discontinuity, at regions 280 (FIG. 2A) and 380 (FIG. 3A). However, other products may require that this discontinuity be minimized or eliminated altogether. This can be accomplished in a simple manner by replacing the larger weft yarns 240, 340 with others having a reduced diameter or thickness equal to D1−N at the seam region such an arrangement is shown in FIGS. 2B and 3B. For example, if the diameter of the weft yarns 240, 241, 242, 243, 244 is D1=1.0 mm and if the Z-direction dimension of the warp yarns 210, 215 or 310, 315 is 0.26 mm, then the weft yarns 240, 340 in the region 220, 320 can be replaced with weft yarns whose thickness is about D1−N=1.0-0.26=0.74 mm as shown in FIGS. 2B and 3B. This will reduce the caliper “t” in this portion of the fabric by the thickness of one warp yarn so that any discontinuity is minimized or eliminated.

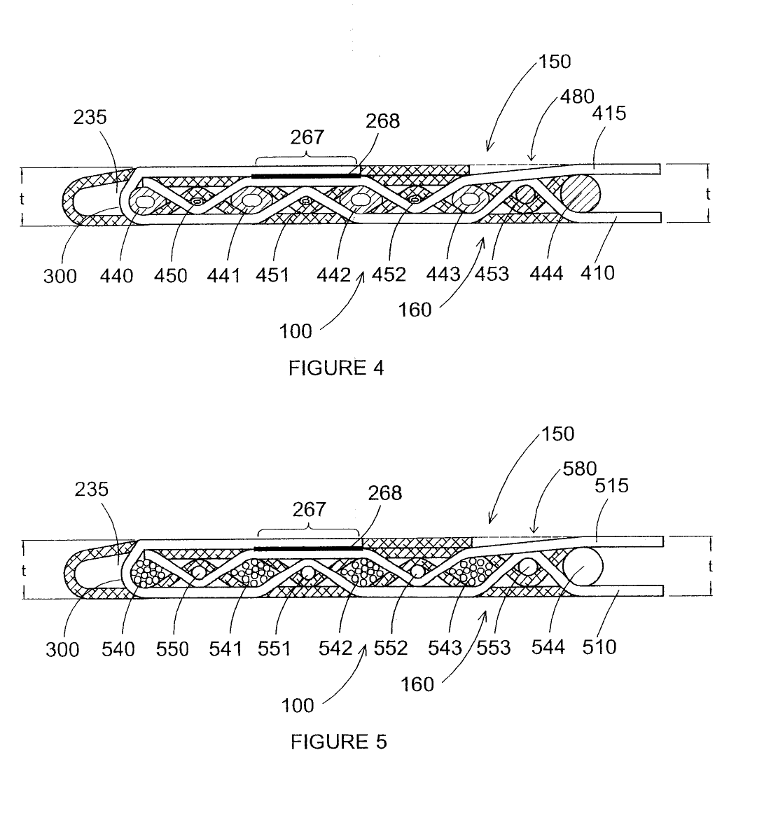

Alternatively, instead of using yarns of a reduced thickness, the effective cross-sectional size can be reduced where required by using hollow yarns, such as are known from U.S. Pat. No. 5,597,450 (Baker et al.) which conventionally have, but are not limited to, a solid fraction of from about 60-75%. An embodiment using such yarns is shown in FIG. 4, in which each of the larger weft yarns 440, 441.442 and 443, and each of the smaller weft yarns 450, 451, 452 and 453 is provided as a hollow yarn, which would deform under heat and pressure, commonly used to flatten the seam region, to reduce the fabric caliper in this area, and reduce the discontinuity at region 480.

As a further alternative, the effective cross-sectional size can be reduced by the use of multifilament yarns or cabled monofilaments, which can be selected to be compressible in a similar manner as hollow yarns. An embodiment using such yarns is shown in FIG. 5, in which each of the larger weft yarns 540, 541, 542 and 543 is provided as a multifilament or cabled monofilament yarn, having suitable characteristics as known to those skilled in the art, in accordance with the specific parameters required for the seam.

As a still further alternative, the effective cross-sectional size can be reduced by the use of heat softenable yarns. These are preferably generally polymeric blends (for example as disclosed in U.S. Pat. No. 6,828,261 to Soelch et al.), or sheath core bi-component yarns which have a relatively soft interior component, or single polymeric component yarns which deform under heat and pressure.

In each of FIGS. 1, 2A, 2B, 3A and 3B, the cross-sectional shape of the weft yarns 240, 250, 241, 251, 242, 252, 243, 253, 244 as shown is circular. However, in addition to the option of using other cross-sectional shapes to reduce the effective size of selected weft yarns, as shown in FIGS. 4 and 5, it is to be understood that the invention can be practised in instances where all the weft yarns in the fabric may have other cross-sectional profiles, including square, rectangular, oval, etc. These other shapes may be preferred to increase the surface area where the bonding is to occur.

Although the seams of the present invention could be formed in a woven structure while the fabric is still on the loom, in most cases, because of factors including the dimensional changes from the conventional heatsetting process, it will be necessary to heatset the fabric before preparing and providing the seams of the invention to the fabric, preferably in the manner below.

For conventional heatsetting, following weaving, the fabric ends are stitched together to render it endless for heatsetting, a process which involves passing it around one or more rotating heated rolls while under tension to soften the yarns and thus set their crimp. This assists in rendering the fabric dimensionally stable so that it can run reliably at a high speed. Once the fabric has been heatset as required, it is removed from the heatsetting frame and the position of the eventual final fabric seam is determined.

The fabric is then prepared for seaming by removing the existing weft yarns from proximate the seaming edge back towards the fabric body a predetermined distance. This releases the warp yarns and forms a fringe area, in which the warp yarns are trimmed back a desired distance and in place of some or all of the weft yarns previously removed, preferably either smaller diameter, hollow yarns, or multifilament/cabled monofilament yarns, or yarns constructed of a material comprising a heat-softenable and deformable polymer, or a combination of such properties, are inserted. This allows the fabric ends at the seam area to later be compressed if necessary to maintain fabric caliper at the seam region consistent with the caliper of the fabric body, thus reducing or avoiding discontinuity.

All of the warp yarn ends are subjected to a combination of heat and pressure so as to restore them substantially to the pre-heatsetting uncrimped shape, i.e. to remove the crimp imparted during heatsetting.

A first group of selected, preferably alternate, warp yarns from each of the fabric edges is bent, or turned back towards the fabric body. This is most easily done by temporarily attaching the selected yarns to e.g. a yarn holder device such as a tie bar, which is laid across a group of the warp yarns. This allows the manufacturer to handle and turn or bend the selected yarns as a group. The yarns are then brought back around a selected last weft at the fabric edge, either over the PS or MS of the fabric, as desired. The tie bar and yarns are pulled back under tension and laid across the selected fabric surface.

The free end of each warp is then bonded back onto selected warp yarns within the weave of the fabric body at selected, preferably flat, surface areas such as warp yarn floats; or to selected weft yarns. A laser, or ultrasonic welding device, or similar bonding means is then brought into proximity of the warp yarns at the selected locations, thereby bonding each of the free warp yarn ends to the respective yarns in the fabric weave. Excess yarn materials at the edge of the bonding locations are cut or severed so that any surplus material is minimized in this region. This first group of selected warp yarns thus forms the retainer loops of the seam region which secure and retain the last weft at the fabric edge in position.

A spacer element having a cross-sectional shape and size to correspond generally with the shape and size of a pintle or coil which will eventually be used to close the final fabric seam is then brought into proximity of the seam face where the retainer loops have been formed, against the exterior surface of the first group of warp yarns where they are folded over the last weft yarn at each fabric edge.

The remaining group or groups of warp yarns are each attached to a yarn holder device such as a tie bar, in a similar manner to the attachment of the first group, and each group in sequence is then bent back around the spacer under tension and toward the fabric body. The free ends of the yarns of each group are then bonded to the respective yarns in the fabric weave at selected, preferably flat, surface areas such as warp yarn floats in a manner similar to that used for the first group of warp yarns which formed the retainer loops. This forms the seaming loops on each end of the fabric; the seaming loops are sized (as a result of the spacer) so as to form a channel which is sized appropriately for the selected joining means that will be used to close the final seam, for example to correspond in shape and size to that of a pintle.

The two fabric ends are then brought together and their seaming loops interdigitated, and the seam is then closed by inserting a pintle or other joining means through the channel formed by the seaming loops.

The seam area is then pressed using heat and pressure so as to reduce fabric caliper at this region and render the seam area continuous in thickness with the fabric body. The seam area is inspected and any loose warp ends are further bonded as required. The area may be sanded or otherwise abraded to minimize or remove any discontinuities that may snag or catch stationary elements in the papermaking machine, or mar the product being transported by the fabric.

The methods of the invention are applicable to forming a seam in any industrial textile, but are particularly suitable for use in fabrics which include monofilament yarns of generally flat or rectangular cross-sectional shape and which are arranged in the machine direction of the fabric such as are described by Buchanan et al. in U.S. Pat. No. 4,209,290 or Lee in U.S. Pat. No. 5,103,874.

Other fabrics containing flat, oval or elliptical warp yarns can be used also, as can round yarns, but fabrics woven using generally flattened yarns as the warp or MD components are preferred due to the higher contact area that can be achieved at the bond.

To form the reinforced seam of the present invention while the fabric is still on the loom, for a fabric having two sets of warp yarns, two warp beams are used to provide yarns for each of the first and second surfaces of the fabric. When the fabric has been woven to the desired length, the reed of the loom is allowed to “beat up” the last weft yarns several times to ensure that they are tightly packed in the fabric and as stable as possible. A laser welding device is brought into proximity of the warp on the last several repeats of the weave pattern on the first surface. The warp yarns are exposed to laser energy along the last weave repeat across the fabric width so as to bond them securely to the weft on this surface. The warp yarns are then carefully cut at or proximate to the last weft yarn at the fabric edge. The warp located on the second surface of the fabric will be used to form the seaming and retainer loops. Alternate warp yarns from the second surface are cut at a distance removed from the fabric edge, and then folded around the fabric edge and bonded in place on top of each of the already bonded warp yarns on the first surface to form the retainer loops. A spacer of suitable size is brought into position at the fabric edge and the remaining warp yarns are folded back over it and then bonded in place beside the warp yarns forming the retainer loops so as to create the seaming loops. Excess yarn material from the seaming and retainer loops is then removed and the opposing fabric edge is then seamed in a separate operation, following which the two opposing fabric edges can be brought together, and the seaming loops interdigitated to form a channel 235, and to allow the two edges to be joined by a pintle or coil.

1-42. (canceled)

43. A seaming area for seamable end regions of a woven industrial fabric, the fabric comprising at least a first set of warp yarns interwoven with weft yarns and having free ends, the first set of warp yarns comprising at least a first group and a second group, the fabric comprising a fabric body and a first and second seamable end region each comprising a fabric edge, wherein at the seaming area
(i) the yarns of the first group pass around and in contact with the fabric edge, and the yarns of the second group pass around the fabric edge to form a plurality of loops protruding from the fabric edge; and
(ii) the free ends of each of the warp yarns of the first set are bonded to yarn material of the fabric body, the yarn material being selected from surfaces of the warp yarns of the first set, surfaces of the weft yarns, and combinations thereof.

44. A seaming area according to claim 43, wherein the fabric comprises at least first and second sets of warp yarns interwoven with the weft yarns in first and second layers, and wherein the yarn material is selected from surfaces of the warp yarns of the first set, surfaces of the warp yarns of the second set, surfaces of the weft yarns, and combinations thereof.

45. A seaming area according to claim 43, wherein the yarns of the first group are alternated with the yarns of the second group, such that the loops in a first seaming area at the first seamable end region are interdigitatable with the loops in a second seaming area in the second seamable end region, and the loops when interdigitated are alignable to receive a seam closure means selected from a pintle and a coil.

46. A seaming area according to claim 44, wherein the first and second sets of warp yarns are provided as stacked pairs such that each yarn of the first set is stacked with a yarn of the second set in a vertical plane through the fabric, and each yarn of the second set is stacked with a yarn of the first set in a vertical plane through the fabric, and the yarn material is selected from surfaces of the warp yarns of the first set, surfaces of the warp yarns of the second set, surfaces of the weft yarns, and combinations thereof.

47. A seaming area according to claim 43, wherein the free ends of each of the warp yarns of the first set are bonded to the yarn material by a bonding step selected from at least one of laser welding, ultrasonic welding, application of an adhesive, and application of chemically reactive materials.

48. A seaming area according to claim 44, wherein free ends of the warp yarns of the second set are secured to surfaces of selective ones of the weft yarns.

49. A seaming area according to claim 43, wherein selected weft yarns adjacent the seam area have an effective thickness in a vertical plane through the fabric which is less than the thickness of the remaining weft yarns in the fabric body, such lesser thickness having a value (D−N) wherein D is the thickness dimension of the remaining weft yarns in the fabric body, and N is the thickness dimension of a selected one of the warp yarns.

50. A seaming area according to claim 49, wherein the selected weft yarns are constructed as hollow yarns.

51. A seaming area according to claim 49, wherein the selected weft yarns are constructed as multifilament yarns.

52. A seaming area according to claim 49, wherein the selected weft yarns are constructed as cabled monofilament yarns.

53. A seaming area according to claim 49, wherein the selected weft yarns are constructed of a material comprising a heat-softenable and deformable polymer.

54. A seaming area according to claim 43, wherein the warp yarns of the first set have a substantially rectangular cross-sectional shape.

55. A seaming area according to claim 44, wherein the warp yarns of the first and second sets have a substantially rectangular cross-sectional shape.

56. A woven industrial fabric comprising at least a first set of warp yarns interwoven with weft yarns and having free ends, the first set of warp yarns comprising at least a first group and a second group, the fabric comprising a fabric body and a first and second seamable end region each comprising a fabric edge, wherein at the seaming area
(i) the yarns of the first group pass around and in contact with the fabric edge, and the yarns of the second group pass around the fabric edge to form a plurality of loops protruding from the fabric edge; and
(ii) the free ends of each of the warp yarns of the first set are bonded to yarn material of the fabric body, the yarn material being selected from surfaces of the warp yarns of the first set, surfaces of the weft yarns, and combinations thereof.

57. A woven industrial fabric according to claim 56, wherein the fabric comprises at least first and second sets of warp yarns interwoven with the weft yarns in first and second layers, and wherein the yarn material is selected from surfaces of the warp yarns of the first set, surfaces of the warp yarns of the second set, surfaces of the weft yarns, and combinations thereof.

58. A woven industrial fabric according to claim 56, wherein the yarns of the first group are alternated with the yarns of the second group, such that the loops in a first seaming area at the first seamable end region are interdigitatable with the loops in a second seaming area in the second seamable end region, and the loops when interdigitated are alignable to receive a seam closure means selected from a pintle and a coil.

59. A woven industrial fabric according to claim 57, wherein the first and second sets of warp yarns are provided as stacked pairs such that each yarn of the first set is stacked with a yarn of the second set in a vertical plane through the fabric, and each yarn of the second set is stacked with a yarn of the first set in a vertical plane through the fabric, and the yarn material is selected from surfaces of the warp yarns of the first set, surfaces of the warp yarns of the second set, surfaces of the weft yarns, and combinations thereof.

60. A woven industrial fabric according to claim 56, wherein the free ends of each of the warp yarns of the first set are bonded to the yarn material by a bonding step selected from at least one of laser welding, ultrasonic welding, application of an adhesive, and application of chemically reactive materials.

61. A woven industrial fabric according to claim 57, wherein free ends of the warp yarns of the second set are secured to surfaces of selective ones of the weft yarns.

62. A woven industrial fabric according to claim 56, wherein selected weft yarns adjacent the seam area have an effective thickness in a vertical plane through the fabric which is less than the thickness of the remaining weft yarns in the fabric body, such lesser thickness having a value (D−N) wherein D is the thickness dimension of the remaining weft yarns in the fabric body, and N is the thickness dimension of a selected one of the warp yarns.

63. A woven industrial fabric according to claim 62, wherein the selected weft yarns are constructed as hollow yarns.

64. A woven industrial fabric according to claim 62, wherein the selected weft yarns are constructed as multifilament yarns.

65. A woven industrial fabric according to claim 62, wherein the selected weft yarns are constructed as cabled monofilament yarns.

66. A woven industrial fabric according to claim 62, wherein the selected weft yarns are constructed of a material comprising a heat-softenable and deformable polymer.

67. A woven industrial fabric according to claim 56, wherein the warp yarns of the first and second sets have a substantially rectangular cross-sectional shape.

68. A woven industrial fabric according to claim 57, wherein the warp yarns of the first and second sets have a substantially rectangular cross-sectional shape.

69. A method of providing a seaming area to a woven industrial fabric, the fabric comprising at least a first set of warp yarns interwoven with weft yarns to provide a fabric body and a first and second seamable end region each comprising a fabric edge, the method comprising the steps of
(a) dividing the warp yarns of the first set proximate each of the fabric edges into at least a first and a second group;
(b) turning the yarns of the first group at the respective fabric edge to pass around and in contact with the fabric edge;
(c) turning the yarns of the second group at the respective fabric edge to pass around the fabric edge to form a plurality of loops protruding from the fabric edge; and
(d) bonding free ends of each of the warp yarns of the first set to yarn material of the fabric body, the yarn material being selected from surfaces of the warp yarns of the first set, surfaces of the weft yarns, and combinations thereof.

70. A method according to claim 69, wherein the fabric comprises at least first and second sets of warp yarns interwoven with the weft yarns in first and second layers, and wherein the selecting of the yarn material in step (d) comprises selection from surfaces of the warp yarns of the first set, surfaces of the warp yarns of the second set, surfaces of the weft yarns, and combinations thereof.

71. A method according to claim 70, wherein the first and second sets of warp yarns are provided as stacked pairs such that each yarn of the first set is stacked with a yarn of the second set in a vertical plane through the fabric, and each yarn of the second set is stacked with a yarn of the first set in a vertical plane through the fabric, and the yarn material is selected from surfaces of the warp yarns of the first set, surfaces of the warp yarns of the second set, surfaces of the weft yarns, and combinations thereof.

72. A method according to claim 70, comprising before step (b) the step of securing free ends of the warp yarns of the second set to surfaces of selective ones of the weft yarns.

73. A method according to claim 69, wherein the dividing in step (a) is performed such that the yarns of the first group are alternated with the yarns of the second group, such that the loops in a first seaming area at the first seamable end region are interdigitatable with the loops in a second seaming area in the second seamable end region, and the loops when interdigitated are alignable to receive a seam closure means selected from a pintle and a coil.

74. A method according to claim 69, wherein the bonding of step (d) comprises a method selected from at least one of laser welding, ultrasonic welding, application of an adhesive, and application of chemically reactive materials.

75. A method according to claim 69, further comprising, before step (a), the step of (a.0) providing selected weft yarns adjacent the seam area having an effective thickness in a vertical plane through the fabric which is less than the thickness of the remaining weft yarns in the fabric body, such lesser thickness having a value (D−N) wherein D is the thickness dimension of the remaining weft yarns in the fabric body, and N is the thickness dimension of a selected one of the warp yarns.

76. A method according to claim 75, wherein the selected weft yarns are constructed as hollow yarns.

77. A method according to claim 75, wherein the selected weft yarns are constructed as multifilament yarns.

78. A method according to claim 75, wherein the selected weft yarns are constructed as cabled monofilament yarns.

79. A method according to claim 75, wherein the selected weft yarns are constructed of a material comprising a heat-softenable and deformable polymer.

80. A method according to claim 69, wherein the warp yarns of the first set have a substantially rectangular cross-sectional shape.

81. A method according to claim 70, wherein the warp yarns of the first and second sets have a substantially rectangular cross-sectional shape.

82. A method of forming a seam for a woven industrial fabric, comprising the steps of
(a) weaving the fabric on a loom;
(b) providing at each seamable end of the fabric a seaming area by the method of claim 69; and
(c) bringing the seamable ends of the fabric together and securing them in the seam.

83. A method according to claim 82, wherein step (b) is performed while the fabric is on the loom.

84. A method according to claim 82, further comprising, before step (b), the step of
(a.1) removing the fabric from the loom.
